(19) United States
(12) Patent Application Publication
(10) Pub. No.: US 2007/0266859 A1
(43) Pub. Date: Nov. 22, 2007

(54) Filter cleaning apparatus

(76) Inventor: Mario Valenzi, Surfers Paraside (AU)

Correspondence Address: Kenton R. Mullins;Stout, Uxa, Buyan & Mullins, LLP, Suite 300, 4 Venture, Irvine, CA, 92618, US

(21) Appl. No.: 11/804,283

(22) Filed: May 16, 2007

(30) Foreign Application Priority Data
May 16, 2006 (AU) AU 2006902612

(51) Int. Cl. B01D 46/04

(52) U.S. Cl. 96/233

(57) ABSTRACT

A filter cleaning apparatus having a canister body for at least partially containing a filter to be cleaned, the canister body having a central longitudinal axis with which the filter in use is located coaxially for cleaning, the filter being mounted for rotation about the central axis. The canister body can also have at least one fluid outlet located within the canister for application of fluid tangentially to the filter, the application of the fluid rotating the filter; and can further include a drain to drain the fluid from the canister.

This application claims the foreign priority of Australian Patent Application No. AU 2006902612, filed on May 16, 2006.

1. Field of the Invention

The present invention relates to filter cleaning apparatus and particularly to apparatus for cleaning swimming pool or spa filters.

2. Background Art

Apparatus for the cleaning of pool filters are available and prior art device include a device described in U.S. Pat. No. 5,384,045 to Chmielewski et al. which also provides an excellent summary of the historical development of filter cleaning devices.

Whilst the device in that document is similar to the present invention in that the pressure of the water directed at the filter forces the rotation of the filter, the device otherwise is quite dissimilar to the device of the present invention (the nozzles are located within a longitudinal channel through the filter).

The background art portion of the specification of the Chmielewski patent includes a reference to U.S. Pat. No. 4,941,971 which describes a device having a horizontally mounted cylindrical container which is adapted to mount through demountable end plates a cartridge filter in the container through demountable end plates for rotation around a lower axis than the centre axis of the container. The combination of container and filter is connected in an aqueous system through a top inlet pipe and hand controlled valve and a lower front end plate outlet, and to a source of pressure cleaning media through an upper quadrant valve controlled turnable tube slidably mounted through a rear plate inlet and supported in the container by a combination track and baffle member fixed to the container top. A nozzle fixed to the free end of the pressure media tube jets cleaning media against the filter to rotate it alternately in both directions of rotation and for its full length. The nozzle also translated back and forth over the length of the filter to clean the filter. A second inlet pipe and valve is fixed to the top inlet pipe a chemical cleaning soak in baffled minimum amounts because of the baffling and filter mounting below the centre of the container. A bottom outlet pipe and valve provides a drain for removal of pressure media and chemical soak soil.

This device has clear disadvantages in cleaning a filter, namely that the nozzles are required to move back and forth along the length of the filter, the filter is mounted horizontally and most importantly, the filter is mounted in the container closer to the bottom wall than to the other walls. This can result in inefficient cleaning of the filter due to material removed from the filter rebounding off the closer sidewall and becoming relodged in the filter. Also, if the lower valve becomes clogged or obstructed for any reason, the pressure media and chemical soak soil can build up and impinge on the filter.

Further, due the filter being mounted horizontally, the water used to clean the filter tends to build-up on the lower side of the filter making that side of the filter much heavier. By having the inlet nozzles on the upper side, in order to force the rotation of the filter, the force of the water nozzles must overcome the weight of the water at the lower side of the filter and the resultant inertia. The build-up of water on the lower side of the filter also tends to retard the rotation speed of the filter and decrease cleaning effectiveness.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a filter cleaning apparatus, which may at least partially overcome at least one of the abovementioned disadvantages or provide the consumer with a useful or commercial choice.

In one form, the invention resides in a filter cleaning apparatus having a canister body for at least partially containing a filter to be cleaned, the canister body comprising: (a) a central longitudinal axis about which the filter to be cleaned can be located coaxially for cleaning, wherein the filter in use can be mounted for rotation about the central axis; (b) at least one fluid outlet located within the canister for application of fluid tangentially to the filter when the filter is mounted for rotation about the central axis, the application of the fluid being capable of rotating the filter; and (c) a drain to drain the fluid from the canister.

The filter cleaning apparatus of the present invention is adapted to hold the filter in a substantially vertical position for cleaning and rotation. The cleaning of the filter can then preferably occur through the fluid which is projected at the filter which rotates the filter.

The cleaning apparatus of the subject invention is designed mainly for cleaning annular filters of a type used in domestic swimming pools although other types and shapes of filter can be cleaned using the apparatus. The annular filters typically have a longitudinally extending opening through the centre of a cylindrical filter which allows easy mounting of the filter for rotation. The apparatus is particularly well adapted to cleaning cartridge type filters.

The filter is normally removed from its operative location within the filtering environment and placed in the apparatus of the present invention. The apparatus is then connected to a hose or similar which can provide the fluid, usually either air or water. The apparatus may also be connected to the pump of the pool, spa or the like with which the filter is used, preferably using a bypass valve or similar so that the pump can pressurise the fluid for cleaning. As the pumps associated with pools, spas and similar are generally quite powerful, the apparatus can incorporate a larger number of outlets and operate at a similar or higher pressure than if a simple hose is used. The filter can then be cleaned in the apparatus for a period of time before removing the filter from the apparatus and replacing the filter in the filtering environment.

The canister body for at least partially containing a filter to be cleaned will preferably be capable of creating a fully enclosed environment and as such may have a base wall and at least one sidewall. It is preferred that the canister is cylindrical as this will preferably decrease the number of corners in the apparatus as corners would form locations for build-up of scum and the like in the apparatus.

The sidewall therefore will be a generally cylindrical sidewall and the base wall will typically be circular. The canister will have an open top, but will preferably be provided with a removable lid or cap to close the open top. The lid or cap may be configured similarly to the canister base and may be provided with attachment means to secure the lid or cap to the canister.

The sidewall of the canister will be high enough to completely contain a filter within the canister. A canister may be dimensioned to contain a large filter but may be used to clean smaller filters.

The base wall will typically have a central rotation point relative to which the filter is located in use and about which the filter is mounted to rotate. This will be the case even where the canister is not circular. The base wall may be provided with a guide for rotation. The guide may be or include a bearing assembly or similar to reduce the friction during rotation.

The guide or bearing assembly may support the filter to be cleaned directly or a further filter supporting portion may be provided for this purpose. Where the guide or bearing assembly directly supports the filter, it should be adapted to support the filter and maintain the filter in location with respect to the central axis of the canister during rotation and cleaning.

The canister is typically manufactured of a light but strong material such as a light metal, or fibreglass or similar and plastic is a particularly preferred material.

Where provided, the filter supporting portion will preferably engage with the guide or bearing assembly to reduce friction and increase or maintain rotational speed of the filter during cleaning, as well as support the filter in the correct location during cleaning.

The guide or bearing assembly (or the filter supporting portion, where provided) will preferably include a receiving member for receiving a lower portion of the filter or a portion of the central opening of the filter. Preferably, the receiving member will include a circular plate with an upstanding sidewall portion at or near the periphery of the plate such that the end of the filter can be received on the plate inside the sidewall in a substantially vertical orientation.

Alternatively, the receiving member may include a circular plate to support the bottom of a filter with a centrally located upstand member to be received within the central opening of the filter.

The plate supporting the filter will typically be spaced :from the base of the canister as this may allow any fluid used for cleaning the filter to accumulate in a lower portion of the canister to drain, but still be separated from the filter so as not to be reapplied to the filter.

The bearing assembly will preferably include one or more circular bearings enhancing rotation of the filter during cleaning. The type of bearing is not particularly important but circular roller, ball bearing or thrust bearings are preferred. Bearings of this type typically include a pair of race rings between which are interposed the rolling elements, these latter usually being held in a form or case or separator.

The rolling elements, which are often made form direct hardening steel or similar (may be plastic or ceramic for example), may be balls, parallel rollers, tapered rollers or barrel-shaped rollers.

The race rings are typically made with parallel fitting seatings.

The cylindrical canister will have a central longitudinal axis about which the filter will be mounted for rotation. The central axis will preferably be oriented substantially vertically and this orientation allows better drainage of the cleaning fluid and also more consistent rotation of the filter during cleaning. The central axis may be defined by or provided with an elongate upstand member to assist with the positioning of the filter by engaging with a central opening in the filter.

The canister has at least one fluid outlet located within the canister for application of fluid tangentially to the filter, the application of the fluid rotating the filter. Typically, there will be a plurality of fluid outlets to spread the fluid over the length of the filter. The inventor has found that providing a number of outlets as opposed to a single outlet which moves longitudinally along the length of the filter during cleaning not only reduces the number of parts in the apparatus and therefore the complexity and breakages or problems, but also provides a superior clean to the filter.

Each of the outlets are preferably shaped to provide a jet of fluid directed tangentially to the filter in order to both clean and rotate the filter. The outlets are typically spaced over the height of the canister and filter. The outlets are preferably oriented in a chord-like direction relative to the filter, so that fluid from the outlets intersects at least the periphery of the filter. The angle of incidence of the fluid from the outlets may be adjustable to provide a deeper or more superficial clean to the filter. Some of the outlets may be directed primarily to rotate the filter and others may be directed primarily to clean the filter, and the two sets of outlets may have different directions.

According to a particularly preferred embodiment of the invention, the plurality of outlets are provided in an elongate member mounted within the canister. The elongate member is typically located laterally of and outside the radius of rotation of a filter properly located within the canister. The elongate member may be moveable within the canister to optimally position the member relative to filters of differing diameters. The elongate member is preferably a hollow cylindrical member which extends substantially vertically from the base of the canister. The elongate member will preferably be in fluid communication with a fluid supply, and the fluid supply will preferably be removeably attachable to the canister to enhance portability of the canister.

According to preferred embodiments, the number of outlets provided differs. For example, according to one preferred embodiment, 8 outlets may be provided. This device is adapted to be operated at a relatively low pressure and can function when operated off domestic mains water pressure. According to an alternative embodiment, the device may be provided with up to approximately 20 outlets. The device of this embodiment may operate off domestic mains water pressure but usually will require a higher pressure than is available through domestic mains pressure.

Therefore, the inventor has configured a system including a three-way valve associated with the pump means associated with the body of water. Usually, after water leaves the pool, it passes through the filter means and thence to the pump means. After the water has passed through the pump means, it proceeds back into the pool. However, with the imposition of a three-way valve, water can be diverted into the cleaning device instead, and the pressure that can be provided by the pool pump is much higher than domestic mains water pressure. Importantly, the water that is being used to clean the filter is then the pool water, not water from the tap. The three way valve may be switchable to provide the high pressure cleaning water as desired and will typically be closed when the cleaning device is not in use, allowing flow in the usual direction only.

This improvement significantly increases the efficiency of the cleaning device. In particular, it uses far less water, and achieves the same level of cleaning in much less time. It also uses water from the pool, so, for example, if the pool was slightly over filled, the cleaning device could use the pool water without wasting domestic water, which may be the subject of user restrictions in amount.

There may be more than one elongate member, each with a plurality of outlets, spaced about the canister.

The canister also includes drain means to drain the fluid from the canister. The drain means will typically be as simple as an opening and generally more than one drain opening will be provided. The openings may be provided in the base of the canister or in a sidewall or a combination may be provided. The drain means may include a collection tray for the collection of the used fluid and will typically be provided either in, or associated with the base of the canister. The drain means may include openings which extend through the filter support portion where provided. Filter means may be provided in associated with the drain means.

The device of the invention operates on a basis which is somewhat different to many of the prior art devices in that it does not rely on centrifugal force generated by the rotation of the filter to clean the filter but rather on the pressure of the water directed at the filter. The rotation of the filter in the present invention is ancillary and directed towards presenting all surfaces of the filter to the outlets for cleaning. Indeed, if the cleaning of the filter was based on centrifugal force generated by rotation then the very force that would be relied on for cleaning would result in the water not penetrating deeply enough to effect any cleaning.

### BRIEF DESCRIPTION OF THE DRAWINGS

An embodiment of the invention will be described with reference to the following drawings, in which:

FIG. 1 is a perspective view of an empty canister of a filter cleaning apparatus according to a preferred embodiment of the present invention.

FIG. 2 is a perspective view of a canister of a filter cleaning apparatus according to a preferred embodiment of the present invention, with a filter in position within the canister.

FIG. 3 is a perspective view of a preferred embodiment of a cap for protecting the thrust bearing assembly.

FIG. 4 is a perspective view from above of a preferred embodiment of the internal filter supporting portion.

FIG. 5 is a perspective view from below of the filter supporting portion illustrated in FIG. 4.

FIG. 6 is a perspective view of a preferred embodiment of the canister with the upper portion of the canister wall removed according to a preferred embodiment of the present invention. The portion as illustrated is also a perspective view of the cap used according to a preferred embodiment of the invention.

### DETAILED DESCRIPTION OF THE PREFERRED EMBODIMENT

According to a preferred embodiment, a filter cleaning apparatus 10 is provided.

As illustrated in the accompanying Figures, the preferred embodiment of the filter cleaning apparatus 10 has a canister body 11 for at least partially containing a filter 12 to be cleaned. The canister body 11 has a central longitudinal axis with which the filter 12 is located coaxially for cleaning. The filter 12 is mounted for rotation about the central axis of the canister 11.

The filter cleaning apparatus 10 of the present invention is adapted to hold the filter 12 in a substantially vertical position for cleaning and rotation. The cleaning of the filter 12 can then occur due to the fluid which is projected at the filter 12 which rotates the filter 12.

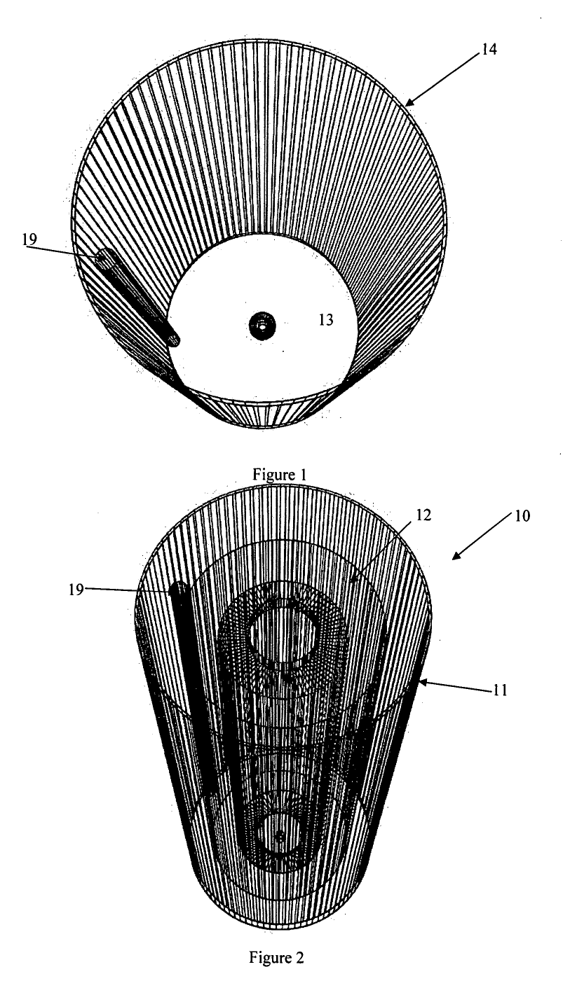

The cleaning apparatus of the subject invention is designed mainly for cleaning annular filters 12 of a type used in domestic swimming pools such as that illustrated in FIG. 2. The annular filters have a longitudinally extending opening through the centre of a cylindrical filter which allows easy mounting of the filter for rotation.

The central axis is oriented substantially vertically and this orientation allows better drainage of the cleaning fluid and also more consistent rotation of the filter 12 during cleaning.

The filter 12 is normally removed from its operative location within the filtering environment and placed in the apparatus of the present invention. The apparatus is then connected to a hose or similar which can provide the fluid, usually water. The filter is then cleaned in the apparatus for a period of time before removing the filter 12 from the apparatus 10 and replacing the filter 12 in the filtering environment.

The canister body 11 for containing a filter 12 to be cleaned is constructed to be capable of creating a fully enclosed environment having a circular base wall 13 and a cylindrical sidewall 14. The canister 11 has an open top, but is provided with a removable lid or cap (not shown) to close the open top of the canister 11.

The sidewall 14 of the canister 11 is high enough to completely contain a filter 12 within the canister 11.

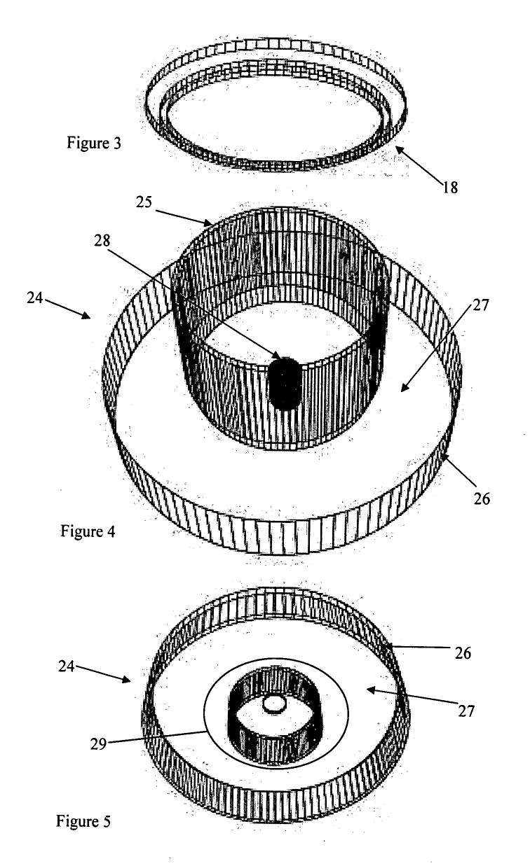

The base wall 13 has a central rotation axis 15 relative to which the filter 12 is located in use and about which the filter 12 is mounted to rotate. The canister 11 is provided with a filter supporting portion 24, as illustrated in FIGS. 4 and 5. The filter supporting portion 24 is located at the bottom of the canister 11. The filter supporting portion 24 is a circular plate member 27 with an inner upstanding wall portion 25 and an outer depending wall portion 26 such that an annular filter can be received about the inner wall portion 25. Located in the centre of the circular plate 27 is an opening 28 through which a bolt or similar fastener extends to secure the filter supporting portion to the canister. There is a removable lid or cap 18 provided, as illustrated in FIG. 3, to close the open top of the inner wall to prevent the ingress of water into the cavity created by the inner wall.

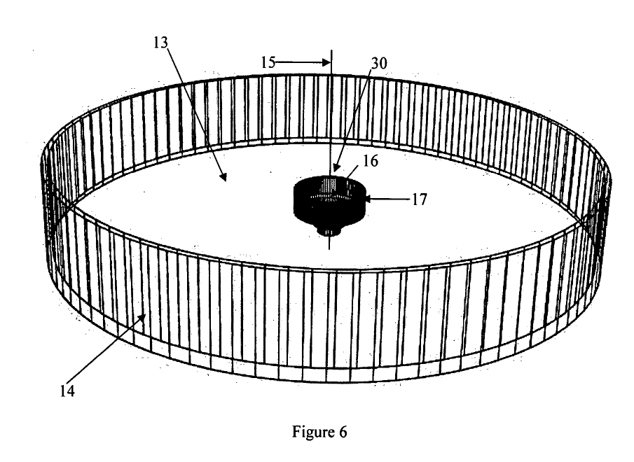

The circular plate of the filter supporting portion 24 is provided with a cup portion 29 extending downwardly from the plate 27. The base of the canister 11 as illustrated in FIG. 6 includes a similar mating cup portion 30 having circular plate 16 with an upstanding sidewall 17 at the periphery of the plate 16. In use, the cup portions 29, 30 engage with each other and between the two is located a thrust bearing (not shown) to reduce friction and increase or maintain rotational speed of the filter during cleaning, as well as support the filter and filter supporting portion 24 in the correct location during cleaning. The mating cup portions 29, 30 are typically watertight.

The plate 16 supporting the thrust bearing 31 is spaced from the base of the canister 11 as this may allow any fluid used for cleaning the filter to accumulate in a lower portion of the canister to drain, but still be separated from the filter so as not to be reapplied to the filter. It also maintains the thrust bearing away from an accumulated liquid.

The canister has a plurality of fluid outlets to spread the fluid over the length of the filter, and located within the canister for application of fluid tangentially to the filter, the application of the fluid rotating the filter.

Each of the outlets is shaped to provide a jet of fluid directed tangentially to the filter 12 in order to both clean and rotate the filter 12.

According to the particularly preferred embodiment of the invention, the plurality of outlets are provided in an elongate member 19 mounted within the canister 11. The elongate member 19 is located laterally of and outside the radius of rotation of a filter 12 properly located within the canister 11. The elongate member is a hollow cylindrical member which extends substantially vertically from the base 13 of the canister 11. The elongate member 19 is in fluid communication with a fluid supply.

The outlets are spaced over the height of the canister 11, elongate member 19 and filter 12. The outlets are oriented in a chord-like direction relative to the filter 12, so that fluid from the outlets intersects at least the periphery of the filter 12.

The canister also includes drain means to drain the fluid from the canister. The drain means will typically be as simple as an opening and generally more than one drain opening will be provided. The openings may be provided in the base of the canister or in a sidewall or a combination may be provided.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A filter cleaning apparatus having a canister body for at least partially containing a filter to be cleaned, the canister body comprising;
(a) a central longitudinal axis about which the filter to be cleaned can be located coaxially for cleaning, wherein the filter in use can be mounted for rotation about the central axis;
(b) at least one fluid outlet located within the canister for application of fluid tangentially to the filter when the filter is mounted for rotation about the central axis, the application of the fluid being capable of rotating the filter; and
(c) a drain to drain the fluid from the canister.

2. The filter cleaning apparatus according to claim 1 wherein the apparatus is adapted to hold the filter in a substantially vertical position for cleaning and rotation.

3. The filter cleaning apparatus according to claim 1 wherein the apparatus is adapted to hold and clean annular filters having a longitudinally extending opening through the centre of the filter by engaging at least a portion of the longitudinally extending opening.

4. The filter cleaning apparatus according to claim 1 wherein the canister body is constructed to be capable of creating a fully enclosed environment having a base wall and at least one sidewall.

5. The filter cleaning apparatus according to claim 1 wherein the canister body is cylindrical.

6. The filter cleaning apparatus according to claim 4 wherein the sidewall is a generally cylindrical sidewall and the base wall is circular, the canister having an open top, and provided with a removable lid or cap to close the open top.

7. The filter cleaning apparatus according to claim 4 wherein the base wall has a central rotation point relative to which the filter is located in use and about which the filter is mounted to rotate.

8. The filter cleaning apparatus according to claim 4 wherein the base wall is provided with a guide for rotation.

9. The filter cleaning apparatus according to claim 8 wherein the guide for rotation supports the filter to be cleaned directly.

10. The filter cleaning apparatus according to claim 8 wherein a further filter supporting portion is provided to support the filter.

11. The filter cleaning apparatus according to claim 10 wherein the filter supporting portion engages with the guide for rotation to reduce friction to maintain rotational speed of the filter during cleaning, as well as support the filter in the correct location during cleaning.

12. The filter cleaning apparatus according to claim 8 wherein the guide includes a receiving member for engaging a lower portion of the filter and/or a portion of the central opening of the filter.

13. The filter cleaning apparatus according to claim 12 wherein the receiving member includes a plate with an upstanding sidewall portion at or near the periphery of the plate such that the end of the filter can be received on the plate inside the sidewall in a substantially vertical orientation.

14. The filter cleaning apparatus according to claim 12 wherein the receiving member includes a plate to support the bottom of a filter with a centrally located upstand member to be received within a central opening of the filter.

15. The filter cleaning apparatus according to claim 12 wherein the receiving member is be spaced from the base of the canister to allow any fluid used for cleaning the filter to accumulate in a lower portion of the canister to drain, but still be separated from the filter so as not to be reapplied to the filter.

16. The filter cleaning apparatus according to claim 1 wherein the central axis is provided with an elongate upstand member to assist with the positioning of the filter by engaging with a central opening in the filter.

17. The filter cleaning apparatus according to claim 1 wherein the canister has a plurality of fluid outlets to spread the fluid over the length of the filter.

18. The filter cleaning apparatus according to claim 17 wherein each of the outlets is shaped to provide a jet of fluid directed tangentially to the filter in order to both clean and rotate the filter.

19. The filter cleaning apparatus according to claim 17 wherein the angle of incidence of the fluid from the outlets is adjustable.

20. The filter cleaning apparatus according to claim 17 wherein the plurality of outlets are provided in an elongate member mounted substantially vertically within the canister, located laterally of and outside the radius of rotation of a filter properly located within the canister.

21. The filter cleaning apparatus according to claim 20 wherein the elongate member is moveable within the canister to optimally position the member relative to filters of differing diameters.

22. A system for cleaning a filter including a filter cleaning apparatus having a canister body for at least partially containing a filter to be cleaned, the canister body comprising:
i. a central longitudinal axis about which the filter to be cleaned can be located coaxially for cleaning, wherein the filter in use can be mounted for rotation about the central axis;
ii. at least one fluid outlet located within the canister for application of fluid tangentially to the filter when the filter is mounted for rotation about the central axis, the application of the fluid being capable of rotating the filter;
iii. a drain to drain the fluid from the canister;
iv. a pump associated in use with a body of water for circulating water from the body of water through a filter; and
v. a valve operable to direct the water from the pump means through the filter and to the filter cleaning apparatus as chosen by a user.
